(19) United States
(12) Patent Application Publication
(10) Pub. No.: US 2017/0084935 A1
(43) Pub. Date: Mar. 23, 2017

(54) Humidifier, for Example for a Fuel Cell

(71) Applicant: Mann+Hummel GMBH, Ludwigsburg (DE)

(72) Inventors: Michael Desjardins, Schoolcraft, MI (US); Stuart Miller, Clayton, NC (US)

(21) Appl. No.: 15/272,595

(22) Filed: Sep. 22, 2016

Related U.S. Application Data
(60) Provisional application No. 62/221,733, filed on Sep. 22, 2015.

(51) Int. Cl. H01M 8/04119; H01M 8/04082

(52) U.S. Cl. CPC H01M 8/04141; H01M 8/04197

(57) ABSTRACT

A humidifier core includes a transfer sheet, a plurality of first channels, and a plurality of second channels. The transfer sheet comprises a permeable material having a plurality of sections and a plurality of layers of spacing materials. The plurality of first channels are configured to allow air flow in a first direction and to prevent airflow in a second direction that is different from the first direction. The plurality of second channels are configured to allow air flow in the second direction and to prevent airflow in the first direction. The humidifier comprises a stack of alternating first channels and second channels, and the first channels are configured to transfer liquid from air flowing in at least one of the first channels to air flowing in at least one of the second channels. A first channel is formed by folding a first section of the transfer sheet under a second section of the transfer sheet with a layer of spacing material provided therein. A second channel is formed by folding a third section of the transfer sheet over the second section of the transfer sheet with a layer of spacing material provided therein. The humidifier is suitable for use in fuel cell stack

### CROSS REFERENCE TO RELATED APPLICATIONS

This application claims the benefit of prior filed U.S. provisional patent application No. 62/221/733, filed on Sep. 22, 2015, the entire contents of which are herein incorporated by reference.

### TECHNICAL FIELD

The invention relates to a humidifier, for example for a fuel cell.

### BACKGROUND

In DE 10 2009 034 095 A1 and EP 1 261 992 B1, humidifiers for fuel cells are described which have a plurality of superimposed membranes which separate flow channels for the feed-through of moist and dry air. Water molecules penetrate the membranes from the moist to the dry air stream which is thus enriched with moisture. The exhaust gas of the fuel cell can be used as moist incoming air stream; the moisture of which exhaust gas is transferred through the membrane into a fresh-air stream which is then fed to the inlet of the fuel cell system in order to generate current in an electrochemical reaction.

### SUMMARY

It is desirable to provide a humidifier having an economical design with which moisture is transferable in an efficient manner from a moist to a dry gas stream, wherein the gas streams are separated from one another.

Furthermore, it is desirable to provide a humidifier having that efficiently transfers moister to the dry gas stream while limiting the transfer of gas to the dry gas steam.

In one embodiment, a humidifier comprises a transfer sheet, a plurality of first channels, and a plurality of second channels. The transfer sheet comprises a permeable material having a plurality of sections and a plurality of layers of spacing materials. The plurality of first channels are configured to allow air flow in a first direction and to prevent airflow in a second direction that is different from the first direction. The plurality of second channels are configured to allow air flow in the second direction and to prevent airflow in the first direction. The humidifier comprises a stack of alternating first channels and second channels, and the first channels are configured to transfer liquid from air flowing in at least one of the first channels to air flowing in at least one of the second channels. A first channel is formed by folding a first section of the transfer sheet under a second section of the transfer sheet with a layer of spacing material provided therein. A second channel is formed by folding a third section of the transfer sheet over the second section of the transfer sheet with a layer of spacing material provided therein.

In one embodiment, a method of manufacturing a humidifier element comprises providing a transfer sheet comprising a permeable material having a plurality of sections. A first section of the transfer sheet is folded under a second section of the transfer sheet. A layer of spacing material is provided between the first section of the transfer sheet and the second section of the transfer sheet. An edge of the first section of transfer sheet is sealed to an edge of the second section of the transfer sheet to form a first channel configured to allow air flow in a first direction and to prevent airflow in a second direction that is different from the first direction. A third section of the transfer sheet is folded over the second section of the transfer sheet. A layer of spacing material is provided between the second section of the transfer sheet and the third section of the transfer sheet. An edge of the third section of the transfer sheet is sealed to an edge of the second section of the transfer sheet to form a second channel configured to allow air flow in the second direction and to prevent air flow in the first direction.

These and other features and objects of the invention will be more fully understood from the following detailed description of the embodiments, which should be read in light of the accompanying drawings.

In this regard, before explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The drawings described herein are for illustrative purposes only of selected embodiments and not all possible implementations, and are not intended to limit the scope of the present disclosure.

In the drawings:

FIG. 1 is a perspective view of a humidifier;

FIG. 2 is a perspective view a media comprising a permeable membrane;

FIG. 3 is a perspective view of the media and a spacing material;

FIG. 4a is a perspective view a first embodiment for sealing two edges of folded media having a spacing material there between;

FIG. 4b is another perspective view a first embodiment for sealing two edges of folded media having a spacing material there between;

FIG. 4c is another perspective view a first embodiment for sealing two edges of folded media having a spacing material there between;

FIG. 5 is a perspective view illustrating how the media is folded and spacing material is provided to form a humidifier core;

FIG. 6 is a perspective of a humidifier core;

FIG. 7 is a perspective view of a humidifier core showing wet and dry airflow.

Corresponding reference numerals indicate corresponding parts throughout the several views of the drawings.

### DESCRIPTION

Example embodiments will now be described more fully with reference to the accompanying drawings.

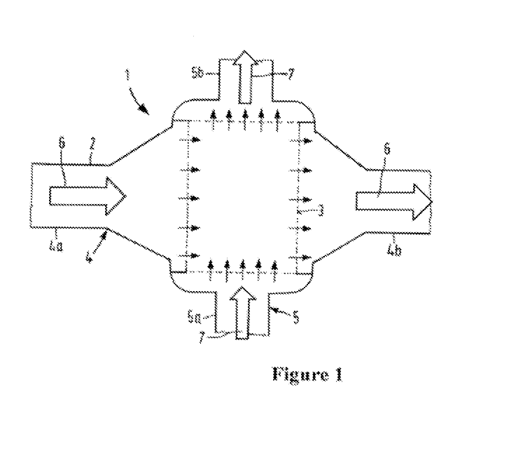

FIG. 1 illustrates a humidifier 1 for a fuel cell, by means of which fresh air enriched with moisture is fed to the fuel cell, said fresh air having a minimum level of humidity. In a housing 2, the humidifier 1 has a cartridge 3 for transferring the moisture contained in an exhaust gas stream 7 to a dry fresh-air stream 6 which is fed to the fuel cell. The cartridge 3 has a stacking unit with a majority of water-permeable fabric layers stacked one above the other, each separating air streams 6, 7 of different moisture content. The fabric layers separate the air streams from one another and simultaneously allow for a moisture exchange between the air streams 6, 7, and so the dry fresh-air stream 6 absorbs moisture from the moist exhaust gas stream 7.

The housing 2 of the humidifier 1 is provided with a fresh-air channel 4, by means of which ambient air is introduced as fresh-air stream 6. The fresh-air channel 4 comprises a feed section 4a upstream of the cartridge 3 and an outflow section 4b downstream of the cartridge.

The housing 2 is provided with an exhaust gas channel 5 which is offset by an angle of 90 degrees relative to the fresh-air channel 4, and by means of which channel exhaust gases of the fuel cell enriched with moisture are guided through the cartridge as exhaust gas stream 7. The exhaust gas channel 5 has a feed section 5a upstream of the cartridge 3 and an outflow section 5b downstream of the cartridge.

The fresh-air stream 6 and the exhaust gas stream 7 intersect according to the alignment of the channels 4 and 5 at an angle of 90 degrees; however, the air streams 6 and 7 within the cartridge 3 are separated by the water-permeable fiber layers which only allow a water exchange from the exhaust gas stream with high moisture content 7 to the dry fresh-air stream 6.

The two gas streams can be arranged at angles other than the substantially 90 degrees shown in the drawing, e.g. as an arrangement in the counter flow with an angle between the two gas streams of substantially 180 degrees, or other advantageous designs.

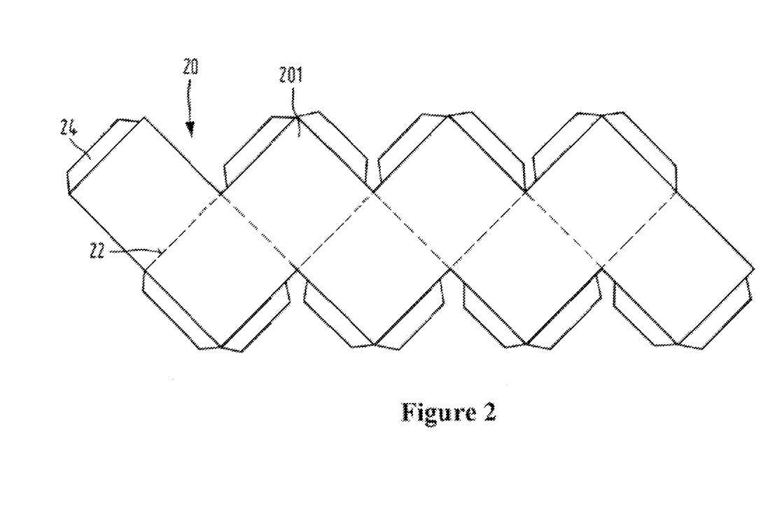

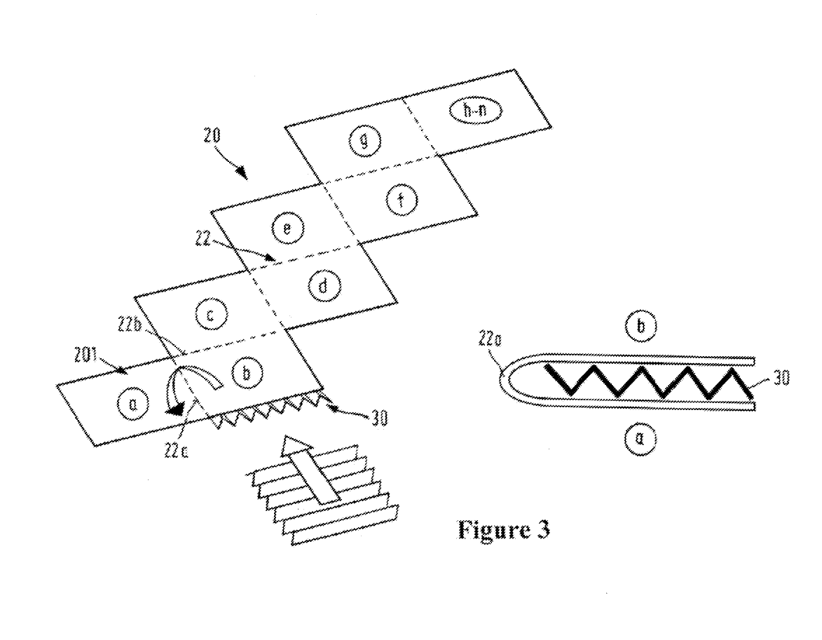

FIG. 2 illustrates a media 20 used in the cartridge 3 of the housing 2 (see FIG. 1). The media 20 comprises a permeable membrane. Cutting the membrane into a specific shape prior to assembly creates the ability to properly fold the cell humidifier core to create alternating flow channels. The sections are folded along fold lines 22 (indicated by dotted lines in the figure), a spacing material 30 is provided between each section, and flaps 24 are utilized to form edges. This is further illustrated in FIG. 3. The alternating flow channels are alternating channels of wet air and dry air in adjacent flow paths to one another. This allows for moisture to be transferred from the wet air to the dry air.

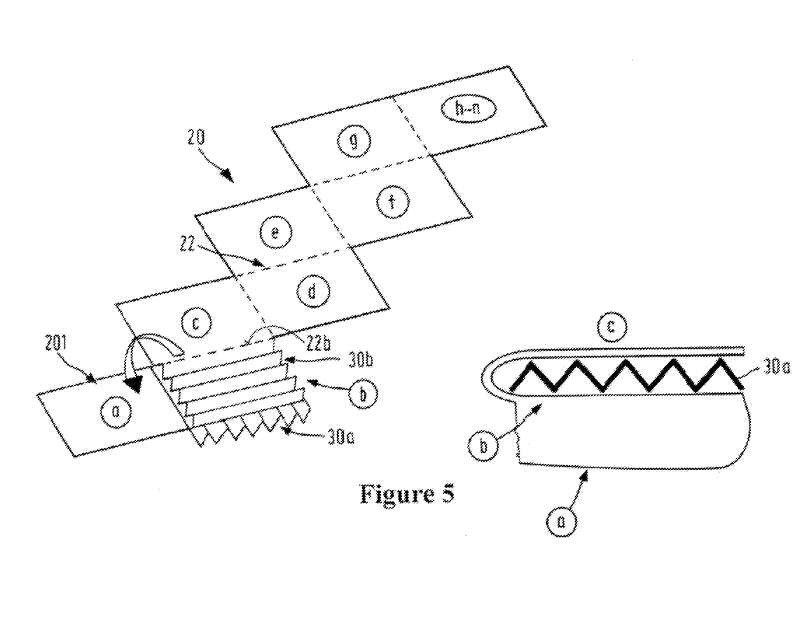

FIG. 3 illustrates a fuel cell humidifier core using the media 20, comprising a permeable membrane 201, and a pleated spun bond plastic spacing material 30 to create a humidifier core element through a series of folds and edge sealing processes. Section 1 of the media 20 is folded along the folding line 22a under section 2 of the media and a layer of spacing material 30 is provided between section a and section b. Section c is folded along folding line 22b above section 2, and another layer of spacing material is provided between section b and section c. This process is repeated for all sections (d through n) until a humidifier core of a desired size is formed. This is further shown in FIG. 5.

The permeable membrane 201 of media 20 seals once it is saturated with liquid, allowing the transfer of liquid from the wet channel to the dry channel without allowing for the transfer of gas from between the wet and dry and channel. A spacing material is provided between the layers of the permeable membrane. The spacing material may be any material that is suitable for creating the desired spacing between the layers without disrupting the flow of air in the channel. For example, the spacing material may be a plastic material or an elastomer.

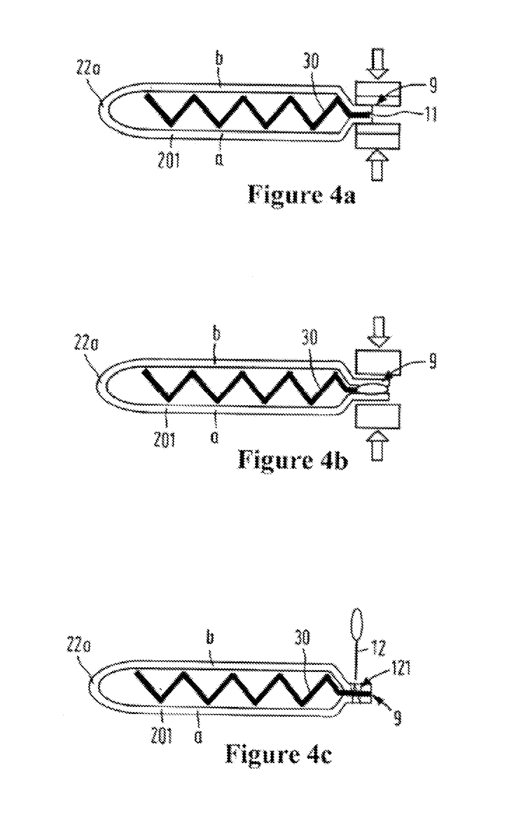

FIGS. 4a-4c illustrate various methods for sealing edges of the channels. In FIG. 4a, a heat and pressure are applied to an open end of the fold capturing both sides of the permeable membrane 201 and a portion of the spacing material 30. The heat and pressure cause the spacing material to bond to both sides of the permeable membrane forming a sealed edge 9.

In FIG. 4b, a bead of a sealing material 11, such as glue or epoxy, is applied to an open edge of the fold prior to folding the membrane 201. The membrane 201 is folded over and pressure is applied to both sides of the membrane. When the sealing material sets or dries, a sealed edge is formed.

In FIG. 4c, a sealed edge 9 is formed by a sewing process. A needle 12 and thread 121 are utilized to seal both sides of the membrane while securing a portion of the spacing material 30 to the membrane 201.

Although three methods of forming a sealed edge 9 are shown, any suitable method of sealing the edge may be utilized. For example, the edge could by sealed by using other known fastening techniques such as stapling or applying a hot melt adhesive.

FIG. 5 illustrates a method of manufacturing a humidifier core 8. The method includes providing the media 20 as a transfer sheet comprising the permeable material having a plurality of sections. A first section a of the transfer sheet is folded under a second section b of the transfer sheet. A layer of spacing material 30a is provided between the first section a of the transfer sheet and the second section b of the transfer sheet. An edge of the first section a of transfer sheet is sealed to an edge of the second section b of the transfer sheet to form a first channel configured to allow air flow in a first direction and to prevent airflow in a second direction that is different from the first direction. A third section c of the transfer sheet is folded over the second section b of the transfer sheet. Another layer of spacing material 30b is provided between the second section of the transfer sheet and the third section of the transfer sheet. An edge of the third section of the transfer sheet is sealed to an edge of the second section of the transfer sheet to form a second channel configured to allow air flow in the second direction and to prevent air flow in the first direction. This process is repeated for the remaining sections of the permeable transfer sheet forming a humidifier element. When the spacing material is a pleated sheet, the alternating layers 30a and 30b are provided with the pleats running in a direction that is substantially perpendicular to the direction of the pleats in the adjacent layer.

An advantage of this method is that the permeable transfer medium can be provided in different sizes resulting in humidifier element having different dimensions. The number of sections is selected to obtain the desired number of channels. The more channels, the higher the transfer rates of fluid from the wet air flow to the dry air flow.

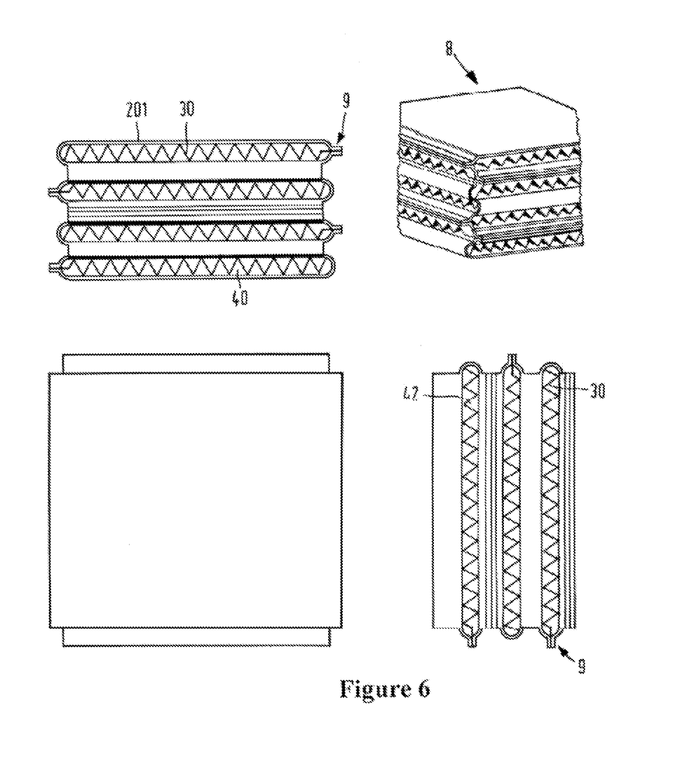

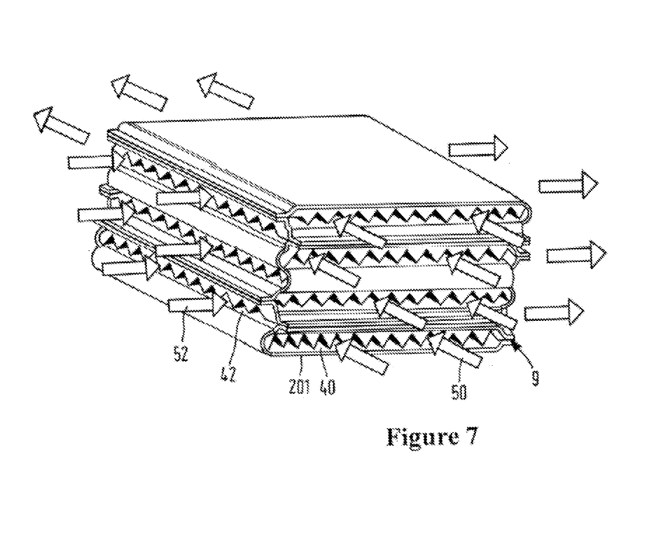

FIG. 6 illustrates various view of a completed humidifier core 8. The humidifier core 8 comprises alternating channels 40,42 having sealed edges 9 in a first direction or a second direction. The sealed edges 9 prevent flow of gas in a particular direction. This enables odd channels 40 to allow gas flow in one direction and even channels 42 to allow gas flow in second direction that is perpendicular to the first direction. Accordingly the odd channels allow only dry air flow and the even channels allow wet air flow. Alternatively, the odd channels allow only wet air flow and the even channels allow only dry air flow. This feature is illustrated in FIG. 7.

FIG. 7 shows that the odd channels 40 allow air to flow in a first direction indicated by arrows 50 while the even channels 42 allow air to flow in a second direction indicated by arrows 52. The first direction is substantially perpendicular to the second direction. If the air flow in the first direction is “wet” air and the air flow in the second direction is “dry” air, the transfer sheet transfers moisture from the wet air to the dry air.

Although the humidifier has been described as being provided in a fuel cell system, the humidifier described herein may be used in any desired humidifier system. For example, the humidifier is suitable for a whole house humidifying system, an industrial humidifying system, and a room humidifying system.

The many features and advantages of the invention are apparent from the detailed specification. Thus, the appended claims are intended to cover all such features and advantages of the invention which fall within the true spirits and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A humidifier element comprising:
a transfer sheet comprising a permeable material having a plurality of sections;
a plurality of layers of spacing materials;
a plurality of first channels configured to allow air flow in a first direction and to prevent airflow in a second direction that is different from the first direction; and
a plurality of second channels configured to allow air flow in the second direction and to prevent airflow in the first direction, wherein the humidifier element comprises a stack of alternating first channels and second channels and the first channels are configured to transfer liquid from air flowing in at least one of the first channels to air flowing in at least one of the second channels; wherein a first channel is formed by folding a first section of the transfer sheet under a second section of the transfer sheet with a layer of spacing material provided therein; wherein a second channel is formed by folding a third section of the transfer sheet over the second section of the transfer sheet with a layer of spacing material provided therein.

2. The humidifier of claim 1, wherein the spacing material comprises a material configured to allow air to flow through the chamber.

3. The humidifier according to claim 1, wherein an edge of the first section is connected to an edge of the second section and another edge of the second section is connected to an edge of the third section.

4. The humidifier according to claim 3, wherein the edges are connected by at least one of melting the transfer sheet, applying an adhesive material, applying a hot-melt material, sewing, or using a fastening device.

5. The humidifier according to claim 1, wherein the first direction is substantially perpendicular to the second direction.

6. A method of manufacturing a humidifier element comprising:
providing a transfer sheet comprising a permeable material having a plurality of sections;
folding a first section of the transfer sheet under a second section of the transfer sheet;
providing a layer of spacing material between the first section of the transfer sheet and the second section of the transfer sheet;
sealing an edge of the first section of transfer sheet to an edge of the second section of the transfer sheet to form a first channel configured to allow air flow in a first direction and to prevent airflow in a second direction that is different from the first direction;
folding a third section of the transfer sheet over the second section of the transfer sheet;
providing a layer of spacing material between the second section of the transfer sheet and the third section of the transfer sheet; and
sealing an edge of the third section of the transfer sheet to an edge of the second section of the transfer sheet to form a second channel configured to allow air flow in the second direction and to prevent air flow in the first direction.

7. The method according to claim 6 further comprising:
folding a fourth section of the transfer sheet over the third section of the transfer sheet;
providing a layer of spacing material between the fourth section of the transfer sheet and the third section of the transfer sheet;
sealing an edge of the fourth section of transfer sheet to an edge of the third section of the transfer sheet to form a third channel configured to allow air flow in a first direction and to prevent airflow in the second direction;
folding a fifth section of the transfer sheet over the fourth section of the transfer sheet;
providing a layer of spacing material between the fifth section of the transfer sheet and the fourth section of the transfer sheet; and
connecting an edge of the fifth section of the transfer sheet to an edge of the fourth section of the transfer sheet to form a fourth channel configured to allow air flow in the second direction and to prevent air flow in the first direction.

8. The method according to claim 7, wherein the first channel is configured to transfer liquid from air flowing in the first channel to air flowing in the second channel, and the third channel is configured to transfer liquid from air flowing in the third channel to air flowing in the fourth channel.

9. The method according to claim 7, wherein the second channel is configured to transfer liquid from air flowing in the second channel to air flowing in the first channel, and the fourth channel is configured to transfer liquid from air flowing in the fourth channel to air flowing in the third channel.

10. The method according to claim 7, wherein connecting an edge of a section of the transfer sheet to an edge of another section of the transfer sheet comprises at least one of melting the transfer sheet, applying an adhesive material, applying a hot-melt material, sewing, or using a fastening device.

11. A humidifier element comprising:
a transfer sheet comprising a permeable material having a plurality of sections;
a plurality of layers of spacing materials;
a plurality of first channels configured to allow air flow in a first direction and to prevent airflow in a second direction that is different from the first direction; and
a plurality of second channels configured to allow air flow in the second direction and to prevent airflow in the first direction, wherein the humidifier element comprises a stack of alternating first channels and second channels and the first channels are configured to transfer liquid from air flowing in at least one of the first channels to air flowing in at least one of the second channels; wherein a first channel is formed by folding a first section of the transfer sheet over a second section of the transfer sheet with a layer of spacing material provided therein; wherein a second channel is formed by folding a third section of the transfer sheet under the second section of the transfer sheet with a layer of spacing material provided therein.
